(19) United States
(12) Patent Application Publication
(10) Pub. No.: US 2011/0036490 A1
(43) Pub. Date: Feb. 17, 2011

(54) METHOD OF JOINING PIPE SEGMENTS USING AN ADHESIVE COMPOSITION

(75) Inventor: Abboud L. Mamish, Marlborough, MA (US)

Correspondence Address: BARNES & THORNBURG LLP, 11 SOUTH MERIDIAN, INDIANAPOLIS, IN, 46204, US

(73) Assignee: BERRY PLASTICS CORPORATION, Evansville, IN (US)

(21) Appl. No.: 12/858,285

(22) Filed: Aug. 17, 2010

Related U.S. Application Data
(60) Provisional application No. 61/234,586, filed on Aug. 17, 2009.

(51) Int. Cl. B29C 63/06; B05D 3/06; B29C 65/14

(52) U.S. Cl. 156/187; 427/558; 156/275.5

(57) ABSTRACT

A method is provided of forming a corrosion-resistant protective coating on a pipe or joint.

### PRIORITY CLAIM

This application claims priority under 35 U.S.C. §119(e) to U.S. Provisional Application Ser. No. 61/234,586, filed Aug. 17, 2009, which is expressly incorporated by reference herein.

### BACKGROUND

The present disclosure relates to a composition for joining and sealing two structures, such as two sections of pipe. More particularly, the present disclosure relates to a composition forming a corrosion-resistant protective coating to cover a pipe joint and to a method of forming a pipe joint using a shrink sleeve.

### SUMMARY

The present disclosure includes a composition joining two sections of pipe. In illustrative embodiments, the present disclosure provides, in one exemplary embodiment, a method of forming a corrosion-resistant protective coating on a pipe or joint, comprising: (a) providing a section of pipe containing at least one joint; (b) providing a sheet of an adhesive composition comprising an acrylic-based adhesive and an initiator; (c) applying the adhesive composition to the pipe section; and, (d) exposing the adhesive composition to UV light for a sufficient period of time so as to cure the adhesive composition and form a permanent coating on the pipe section.

Another aspect of the present disclosure provides a method of forming a corrosion-resistant protective coating on a pipe or conduit joint, comprising: (a) providing a section of pipe containing at least one joint and a line coating area; (b) providing a sheet of an adhesive composition comprising a 2-ethyl-hexyl acrylate and an initiator; (c) wrapping the adhesive composition onto the pipe section so as to overlap the line coating area edges; and, (d) exposing the adhesive composition to UV light for between about 1 and about 6 minutes so as to cure the adhesive composition and form a permanent coating on the pipe section.

### DETAILED DESCRIPTION

In one exemplary embodiment the present disclosure provides a composition comprising a UV curable monolayer adhesive. The material may be an acrylic-based adhesive composition. It is preferable that the adhesive composition be either transparent or translucent. The adhesive composition may be an epoxy-type adhesive, but, it is preferable that the composition not be brittle. It is preferable that the adhesive composition possess a certain amount of tackiness, for example, by incorporating a tackifier material, such as in the film. Alternatively, the composition may possess pressure sensitive properties. The composition preferably can adhere to steel and to polypropylene line coating to create a permanent or a strong bond, and provide the joint area protection from corrosion and resistance to exposure to chemicals, vapor, and the external environment.

A number of acrylic-based adhesives can be used. Examples include, but are not limited to, one or more 2-ethyl-hexyl acrylates (“2EHA”), optionally including other initiators. For bonding to polypropylene, an adhesive composition formulated for polypropylene is preferred.

Pressure sensitive adhesives which may be usable with the composition and method of the present disclosure are described in International Publication No. WO 2008/116033 A2 (International Application No. PCT/US2008/057574) entitled “Pressure Sensitive Adhesives and in International Publication No. WO 2009/117654 A1 (International Application No. PCT/US2009/037800) entitled “Acrylic Polymers Having Controlled Placement of Functional Groups” (the disclosures of both documents being incorporated by reference in their entirety herein).

Upon exposure to UV light the adhesive composition will crosslink and harden, while adhering to the substrates in which it is in contact to form a structural bond.

One exemplary method of forming a seal comprises a first step of providing two sections of pipe in an abutting relationship. A second step is to apply the adhesive composition to the pipe joint area overlapping the edges of the line coating. The protecting coating can be applied to the joint area by any of a number of techniques known to those skilled in the art, such as, but not limited to, spraying, troweling, painting, squeegeeing, pumping via a conduit from a reservoir, hand-applying, using a glue gun or other pressurized liquid dispenser, dispensing from a tube, or the like. A third step is to expose the wrapped adhesive composition to UV light for several minutes to initiate the reaction and complete the curing of the composition. The time of exposure to UV light may vary depending on the composition, the thickness of the adhesive layer, the transparency of the composition, the energy level emitted by the UV source, further initiator content, and other parameters. In general, one exemplary range of curing time may be in the range of about 1-6 minutes. Preferably, the curing time may be in the range of about 2-5 minutes. More preferably, the curing time may be in the range of about 2-3 minutes. Shorter (or possibly longer) cure times may be used depending on various factors, including those described hereinabove. It is preferable for the applied coating to be exposed to UV light generally uniformly around the circumference of the exposed surface. This may be accomplished by using several UV light sources, a single UV light source plus mirrors (or other reflective or directing or focusing means) positioned at various angles around the pipe joint area, curved UV light sources, or other suitable configurations. The UV light can penetrate substantially the entire film layer because the film is either transparent or translucent; thus, curing of all or substantially all of the film will occur.

In another exemplary embodiment, the adhesive composition as disclosed above can be applied to the joint area and then a layer of transparent film, such as, but not limited to, a film, tape, shrink sleeve or the like, comprising, for example, a polyolefin-based material, can then be wrapped around the area in which the adhesive composition is applied. The wrapped film may be maintained in place by any of several mechanisms known to those skilled in the art. Then both the adhesive composition and the transparent film can be cured at the same time as described hereinabove. The film layer can function as a protective layer to provide mechanical protection and prevent damage to the joint coating during handling. For the purposes of the present disclosure, the term film is intended to mean a generally flat sheet of material which is preferably solid (to provide a relatively impermeable barrier when applied and cured). The film may optionally incorporate at least one reinforcing material, such as, but not limited to, fibers, threads, filaments, granules, powder, a mesh, a grid, combinations thereof, and the like. The reinforcing material may be Fiberglas or other material. The film may be formed as a sheet, roll, tape, patch, or other shape or configuration.

The compositions and methods disclosed herein are well-adapted for use in joining pipe units to form a continuous elongated pipe to be deposited onshore or offshore along a sea bed by a lay barge. By using a UV-curable adhesive film as described in the present disclosure, the process is simplified and the time to install the adhesive is reduced compared to heat-activated shrink sleeves, which is essential to field applications, especially offshore jointing activities, which are normally time sensitive. The presently disclosed method reduces installation time, in part, because of the elimination of the pre-heating time of the steel surface (for steel pipe jointing) and elimination of the cooling time associated with heat-activated shrink sleeve installation. Greater control over application accuracy is also provided, which ensures a void-free sealed surface. The simplified procedure reduces the chance of operator application error. Furthermore, the present disclosure eliminates the use of open flames (e.g., gas torch) to shrink a sleeve. The method as described herein also maintains its efficiency in cold temperature, windy, or wet environments.

The compositions and methods disclosed herein can be used in a variety of applications where heat-activated shrink sleeve methods or other heat or irradiation curing methods may be currently used. The present disclosure is well-adapted for use where the pipe or conduit material to be joined is heat sensitive (for example, PVC, Plexiglas, glass, ceramic, wood, or the like) or where heat or an open flame is not advisable or dangerous (such as were volatile vapors are present). Furthermore, the present disclosure is not limited to joining pipes; it can be used to apply an adhesive to any type of substrate or substrates, be it flat or irregular shaped surfaces or joining different types of materials (for example, joining PVC to steel or joining PVC to Plexiglas).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

The disclosure will be further described in connection with the following examples, which are set forth for purposes of illustration only. Parts and percentages appearing in such examples are by weight unless otherwise stipulated.

### EXAMPLES

### Example 1

Preparation of Random Acrylic Polymer Containing Methacrylic Acid. (Low Molecular Weight Version)

An acrylic copolymer with methacrylic acid distributed randomly throughout the polymer backbone was prepared as follows. Into a 1,500 ml reactor equipped with a heating jacket, agitator, reflux condenser, feed tanks and nitrogen gas inlet there was charged 54.8 g of ethyl acetate, 8.87 g isopropanol and 25.06 g acetone. Monomers were added in the following amounts:

74.3 g butyl acrylate

20.37 g tert-butyl acrylate

The reactor charge was heated to reflux conditions (reactor jacket 85° C.) with a constant nitrogen purge. Once solvent reflux was attained, an initiator solution of 0.19 g benzoyl peroxide (Luperox™ A) and 4.24 g ethyl acetate was added to the reactor. After a peak temperature of 76-78° C. was attained, a reagent feed mixture with an active nitrogen purge of 286.3 g ethyl acetate, 31.8 g isopropanol, 364.9 g butyl acrylate, 100.0 g tert-butyl acrylate, 2.96 g methacrylic acid and 1.04 g Luperox™ A was added over a period of three hours to the reactor. Over the three hour reagent feed the temperature of the reaction was held under reflux conditions at 75-79° C. The reaction conditions were maintained for 30 minutes after completion of the reagent feed. A mixture of 1.54 g t-amylperoxy pivalate (Luperox™ 554) and 37.15 g of ethyl acetate was added to the reactor over a period of 30 minutes. The reaction was held at reflux conditions for an additional hour at which point it was diluted with 120 g of ethyl acetate. The resulting solution polymer was then cooled to ambient temperature and discharged from the reactor.

The resulting acrylic polymer contained 77.93% butyl acrylate, 21.36% tert-butyl acrylate, and 0.526% methacrylic acid based on 100% by weight of the acrylic polymer. The molecular weight of the acrylic polymer was 30,800 g/mole (determined by gel permeation chromatography relative to polystyrene standards) and the polydispersity was 3.1. Then, 210 g of 100% solids polymer was dissolved in 90 g of ethyl acetate to yield a solution acrylic.

Physical Testing:

| | | | |
|---|---|---|---|
| Solids | 52.8 | Tsc % | 40 min. in 120° C. oven |
| Viscosity | 590 | cps | Brookfield RV Viscometer, spindle #5 |
| | | | @ 100 rpm, 73.6% torque |

| | | |
|---|---|---|
| % Conversion | 98.0% | gas chromatography |

Aluminum acetoacetonate in an amount of 1.0% based on solids and 20% based on solids terpene phenolic resin was added to the acrylic polymer. The adhesive composition was dried at 90° C. for 20 minutes to ensure complete cross-linking of the acrylic polymer.

### Example 2

The material of Example 1 was diluted to 30,000 CPS (Brookfield viscometer, spindle #5, 10 rpm) with ultraviolet and thermally curable diluents. The adhesive composition was coated onto a metal (steel) substrate and a polyester release film was applied to level the adhesive to 30 to 40 mil thickness. The film was exposed to 950 milli-Joules/cm² of radiation from a 600 watt metal halide bulb for about 60 seconds and then post-cured at 130° C. until a cured film resulted.

### Example 3

The film of Example 2 had the following properties:

| | |
|---|---|
| Thickness | 75 mils |
| Pull-off adhesive strength | 1st sample: 2850 psi |
| (using ASTM standard D4541) | 2nd sample: 1301 psi (glue failure) |
| Impact strength | >120 in. lb at room temp. (23° C.); |
| (using ASTM standard G14) | 99 in. lb at −5° C. |

1. A method of forming a corrosion-resistant protective coating on a pipe or joint, comprising
(a) providing a section of pipe containing at least one joint area,
(b) providing an adhesive composition comprising an acrylic-based adhesive and an initiator,
(c) applying said adhesive composition to said pipe section, and
(d) exposing said adhesive composition to UV light for a sufficient period of time so as to cure said adhesive composition and form a permanent coating on said pipe section.

2. The method of claim 1, further comprising applying a layer of transparent film comprising a polyolefin-based material to said adhesive composition after said adhesive composition is applied to said pipe section.

3. The method of claim 1, wherein said adhesive composition further comprises a tackifier.

4. The method of claim 1, wherein said adhesive composition is in the form of a sheet, roll, tape, or patch.

5. The method of claim 1, wherein the film has
(a) thickness of 75 mils,
(b) pull-off adhesive strength (using ASTM standard D4541) of between 1301 and 2850 psi, and
(c) impact strength (using ASTM standard G14) of greater than 120 inch lb at room temp. (23° C.) and 99 inch lb at -5° C.

6. A method of forming a corrosion-resistant protective coating on a pipe or conduit joint, comprising
(a) providing a section of pipe containing at least one joint and a line coating area,
(b) providing a sheet of an adhesive composition comprising a 2-ethyl-hexyl acrylate and an initiator,
(c) wrapping said adhesive composition onto said pipe section so as to overlap the line coating area edges, and
(d) exposing said adhesive composition to UV light for between about 1 and about 6 minutes so as to cure said adhesive composition and form a permanent coating on said pipe section.

7. The method of claim 6, wherein the film has
(a) a thickness of 75 mils,
(b) pull-off adhesive strength (using ASTM standard D4541) of between 1301 and 2850 psi, and
(c) impact strength (using ASTM standard G14) of greater than 120 in. lb at room temp. (23° C.) and 99 in. lb at -5° C.
